(19) United States
(12) Patent Application Publication
(10) Pub. No.: US 2026/0079824 A1
(43) Pub. Date: Mar. 19, 2026

(54) DETERMINING WHETHER APPLICATION UNDER TEST PERFORMS INTENDED FUNCTIONALITY USING LARGE LANGUAGE MODEL

(71) Applicant: MICRO FOCUS LLC, Wilmington, DE (US)

(72) Inventors: Anton Kaminsky, Yehud (IL); Menachem Mateh, Yehud (IL); YunSheng Liu, Shanghai (CN); Eyal Luzon, Yehud (IL); Dror Saaroni, Yehud (IL)

(73) Assignee: MICRO FOCUS LLC, Wilmington, DE (US)

(21) Appl. No.: 18/886,716

(22) Filed: Sep. 16, 2024

(51) Int. Cl. G06F 11/36

(52) U.S. Cl. CPC G06F 11/3692; G06F 11/3688

(57) ABSTRACT

An application under test (AUT) is tested to determine whether the AUT performs intended functionality. A user generates a verification statement regarding the test results of an application under test (AUT). A prompt to input to a large language model (LLM) is generated based on the test results and the verification statement. The prompt is generated to solicit a response from the LLM including at least whether the test results of the AUT satisfy the verification statement. The generated prompt is provided as input to the LLM, and the response is received as output from the LLM. Whether the AUT performs the intended functionality is determined based on the received response.

### BACKGROUND

Computing devices like desktop, laptop, and other types of computers, as well as mobile computing devices like smartphones, among other types of computing devices, run software, which can be referred to as applications, to perform intended functionality. An application may be a so-called native application that runs on a computing device directly, or may be a web application or “app” at least partially run on a remote computing device accessible over a network, such as via a web browser running on a local computing device. To ensure that an application has been developed correctly to perform its intended functionality (i.e., to ensure that the application is operating as expected), the application may be tested.

### BRIEF DESCRIPTION OF THE DRAWINGS

FIG. 1 is a diagram of an example process for using a large language model (LLM) to determine whether an application under test (AUT) performs its intended functionality.

FIG. 2 is a diagram of an example LLM prompt to provide to an LLM to determine whether test results of an AUT indicate that the AUT performs its intended functionality.

FIG. 3 is a diagram of an example system computing system for using an LLM to determine whether an AUT performs its intended functionality.

FIG. 4 is a diagram of an example non-transitory computer-readable data storage medium storing example program code for using an LLM to determine whether an AUT performs its intended functionality.

FIG. 5 is a flowchart of an example method for using an LLM to determine whether an AUT performs its intended functionality.

### DETAILED DESCRIPTION

As noted in the background, an application is a computer program that is run, or executed, to perform intended functionality. An application may be tested to ensure that the application performs its intended functionality correctly. An application being tested can be referred to as an application under test (AUT). An AUT may expose a graphical user interface (GUI). During testing, different parts of the GUI can be actuated, or selected, in defined sequences of test commands of a test script to verify that the AUT operates as expected.

A user, such as a testing engineer who is responsible for testing an AUT, usually has to create a verification statement using relatively complex code or regular expressions against which test results of the AUT can be analyzed to determine whether the AUT is performing its intended functionality. However, this process can be cumbersome, as the user has to contemplate all possible output values that the test results may include and ensure that they are handled properly via the verification statement. Furthermore, verification statements written in the form of code or regular expressions can be difficult to understand.

For example, an AUT may be tested via a test script that searches for products containing the key phrase “men shoes” but that do not include a specified brand of shoes. A verification statement using regular expressions may be \hat{ }(?:(?!Brand).)*(Men.*Shoes|Shoes.*Men)(?: (?!Brand).)*$ where “Brand” is a specified brand of shoes. This statement is difficult to understand, and a user has to have sufficient skill in regular expressions to create it.

As another example, an AUT may be tested via a test script that searches for flights such that departure times are returned in a particular format, such as time of departure followed by day of the week, and then followed by month, day, and year in that order. A verification statement may be generated in program code that extracts each component of the response (e.g., departure time, day of the week, and so on), and ensures that each component is present and in the correct order. Such program code may also be difficult to understand, and similarly a user has to have sufficient programming skill to create it.

Techniques described herein leverage large language models (LLMs) to analyze test results of an AUT to determine whether the AUT is performing its intended functionality. An LLM prompt can be generated based on a user-generated verification statement that may be in the form of a natural language statement as to how to determine whether the test results indicate whether the AUT is operating as expected. Such a statement is easier to understand and does not require any programming skills or skills in regular expressions for the user to create.

For example, for an AUT that is tested to search for products containing the key phrase “men shoes” but that do not include a specified brand of shoes, the verification statement can simply be “verify that the text returned by the AUT contains ‘men’ and ‘shoes’ and does not contain ‘Brand.’” As another example, for an AUT that is tested to search for flights such that departure times are returned in a particular format as described above, the verification statement may simply be “verify that the format of the departure time returned by the AUT includes the time of departure followed by the day of the week, and then followed by the month, day, and year in that order.”

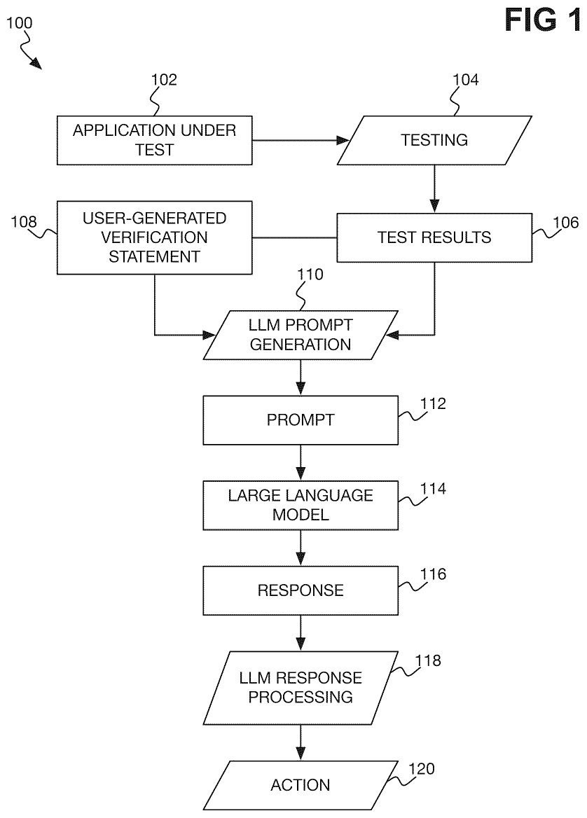

FIG. 1 shows an example process 100 for using an LLM 114 to determine whether an application under test (AUT) 102 performs its intended functionality (i.e., whether the AUT 102 is operating as expected). Testing is performed on the AUT 102 (104), which results in the generation of test results 106. For example, the AUT 102 may be tested by playing back a test script of test commands (e.g., ordered steps), which may have been initially recorded by monitoring a user perform the test commands in a specified sequence. The test script can then be played back in an automated matter without user interaction or assistance to test the AUT 102.

The test results 106 can include the output of the AUT 102 as each test command or ordered step of the test script is performed, or just the output of the AUT 102 after the final command or step is performed. The test results 106 can be in the form of the communication received from the AUT 102 when executing the test script, which may be in a specified markup language or other format. The test results 106 may additionally or instead be in the form of one or more screenshots of the GUI exposed by the AUT 102 during execution of the test script, which may then be subjected to optical character recognition (OCR) to identify text within the GUI screen shots.

A user generates a verification statement 108 regarding the test results 106 of the AUT 102. The verification statement 108 can be in a natural language statement as to how to determine whether the test results 106 indicate that the AUT 102 is performing its intended functionality (i.e., whether it is operating as expected), examples of which have been described above. The user can be the testing engineer who is responsible for testing the AUT 102, and who may not have regular expression or programming skill. The verification statement 108 can be generated before testing has been performed on the AUT 102 and thus before the test results 106 are generated. In this case, the user-generated verification statement 108 indicates how to determine, once the test results 106 have been received, whether the AUT 102 is operating correctly.

Once testing has been performed on the AUT 102 and the verification statement 108 has been generated by the user, an LLM prompt 112 is generated based on the test results 106 and the statement 108 (110). The LLM prompt 112 is generated to solicit a response from the LLM 114 including at least whether the test results 106 satisfy the user-generated verification statement 108—i.e., whether the test results 106 indicate that the AUT 102 is operating as expected in accordance with the verification statement 108. The LLM prompt 112 is then provided as input to the LLM 114, and a response 116 is accordingly received as output from the LLM 114.

The LLM 114 may be GPT-4 or newer (available from OpenAI, Inc.); Claude 3 Sonnet or Opus or newer (available from Anthropic PBC); Gemini Pro 1.5 or Ultra or newer (available from Google LLC); or Llama 3 70B Instruct or newer (open source, available from Meta Platforms, Inc.); among others. The LLM 114 may be a pretrained LLM, which has not been trained for the purposes of application testing, either in a pretraining stage in which the LLM is fed a large corpus to text to learn to predict the next word based on previous words, or in a finetuning stage in which the next word predictor is adapted to behave, for instance, as a chatbot.

The LLM response 116 is processed to determine whether the AUT 102 performs its intended functionality, based on the response 116 (118). Such processing can entail parsing the received response 116 to determine whether it specifies that the LLM 114 has determined the test results 106 indicate that the AUT 102 is operating as expected in satisfaction of the user-generated verification statement 108, for instance. The processing may additionally or instead include other analysis, such as in the case where the prompt 112 is designed to solicit further information from the LLM 114. For example, the prompt 112 may be designed to solicit a confidence value from the LLM 114 as to its conclusion that the AUT 102 is or is not performing as expected. If the confidence value is below a threshold, the conclusion is deemed not credible.

As another example, the prompt 112 may be designed to solicit an explanation from the LLM 114 as to how it performed its analysis of the test results 106 in determining whether the test results 106 indicate that the AUT 102 performs its intended functionality in satisfaction of the verification statement 108. In this case, the processing can include analyzing the explanation to assess whether the reasoning that the LLM 114 provided justify its conclusion is viable, such that the LLM 114's conclusion is not deemed credible if the reasoning does not make sense.

An action may be performed based on the LLM response 116 based on whether the AUT 102 has been determined to have performed its intended functionality (120). The action may include simply outputting or displaying the LLM 114's conclusion as to whether the test results 106 indicate that the AUT 102 is operating as expected in accordance with the user-generated verification statement 108. The action may additionally or instead include revising the source code of the AUT 102 in the case where the AUT 102 is not performed its intended functionality correctly. The action can include other actions as well, such as automatically reconfiguring computing devices based on whether the AUT 102 has been determined to operate as expected.

For instance, the AUT 102 may be a web app that runs on a remote server computing device and that is accessible over a network via web browsers running on local client computing devices. In this case, the AUT 102 undergoing testing may be a new version that is undergoing development to provide additional functionality, where such testing may be performed at least to ensure that existing functionality of the AUT 102 is still operating correctly. If the new version of the AUT 102 has been determined to perform such existing functionality correctly, the action may include reconfiguring the server computing device so that the new version is exposed to client computing devices in lieu of the current version of the AUT 102.

The action that is performed may also include a sequence of actions, and further the action or actions may be conditional in nature. For instance, depending on the verification results of the AUT 102, different action or actions may be performed. In particular, if the AUT 102 is determined to be operating correctly, one or more certain actions may be performed, and if instead the AUT 102 is determined to not be operating correctly, then one or more certain other actions may be performed.

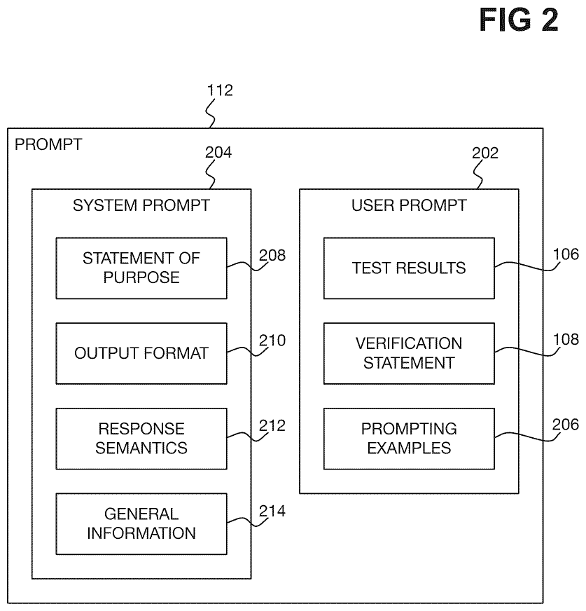

FIG. 2 shows an example of a prompt 112 that is generated and provided as input to the LLM 114 to determine whether the test results 106 indicate that the AUT 102 is performing its intended functionality. In the depicted example, the prompt 112 can include a system prompt 204 and a user prompt 202. The system prompt 204 is not specific to the AUT 102 nor to the intended functionality of the AUT 102, the user-generated verification statement 108, or the test results 106. The system prompt 204 can, however, be specific to the particular LLM 114 to which the prompt 112 will be input.

The user prompt 202, by comparison, is specific to the verification statement 108 as well as to the test results 106, and in some cases may also depend on the particular LLM 114 to which the prompt 112 will be input. Each of the prompts 202 and 204 can, as one example, be a separate file formatted in a markup language, such as XML or JSON. The prompts 202 and 204 may be part of the same file as well, and the file or files may be formatted in a different way, too, such as in plain text.

It is noted, however, that in other implementations, the prompt 112 may not be divided between a system prompt 204 and a user prompt 202. For example, there may just be a single prompt constituting the prompt 112. A particular LLM 114, for instance, may not accept separate system and user prompts 202 and 204. In this case, the information ascribed to each of the prompts 202 and 204 below may be concatenated into a single prompt as the prompt 112.

The system prompt 204 can be generated by a different user than that who generates the verification statement 108. For example, the verification statement 108 may be generated by a testing engineer who is responsible for testing the AUT 102. The system prompt 204 may be generated by a prompting engineer who may be generally familiar with application testing but who may not be as skilled as the testing engineer. The prompting engineer may be an expert or other skilled user in generating information that can be provided as part of the prompt 112 to solicit a desired response 116 from the LLM 114.

The system prompt 204 can include a statement of purpose 208 of the LLM 114 as to its role and what the LLM 114 is expected to do in generating the response 116. The statement of purpose 208 can be provided in natural language format. The statement of purpose 208 can indicate to the LLM 114 that it is expected to review and analyze the test results 106, and identify whether the LLM 114 believes the test results 106 satisfy the verification statement 108 and thus whether the AUT 102 is performed its intended functionality. The statement of purpose 208 can provide limits to the LLM 114 as to the information the LLM 114 should consider when performing this analysis, and/or what information the LLM 114 should consider.

The statement of purpose 208 may be multiple sentences to multiple paragraphs in length. The role that the LLM 114 is to have may be provided as the type of human user the LLM 114 is to behave as when analyzing the test results 106 vis-à-vis the verification statement 108. Providing this information in this way may be able to leverage whatever knowledge the LLM 114 has as to how a human user would analyze the test results 106 in the capacity of being a testing engineer, for instance, as opposed to analyzing the test results 106 in a manner that would otherwise be inscrutable when subjected to verification for correctness and completeness.

The system prompt 204 can include an output format 210 of the response 116 that the LLM 114 is to output. That is, when providing the response 116, the LLM 114 is expected to provide the response 116 in the output format 210. The output format 210 may also be provided in natural language form, describing in human-readable form how the various parts of the response 116 are to be returned. The output format 210 may specify, for instance, the type of document that the LLM 114 should output (e.g., an XML document or a JSON file), and the various elements in that document (e.g., XML or JSON elements). For each element, the output format 210 can specify the possible values that the LLM 114 can select for the element.

The system prompt 204 can include response semantics 212 of the response 116 that the LLM 114 is to output. The semantics 212 may, for instance, provide information as to what the different values the LLM 114 can choose from for various parts of the response 116, what the different values mean, and why the LLM 114 may choose one value as opposed to another value. The response parts can include an indication as to whether the test results 106 satisfy the verification statement 108, such that the semantics 212 can include when different values should be chosen based on whether the LLM 114 believes the test results 106 satisfy the verification statement 108. For example, the values may correspond to “the AUT 102 is operating as expected per the verification statement 108”; “the AUT 102 is not performing its intended functionality”; and “unsure as to whether the AUT 102 is operating correctly.”

The response semantics 212 can include information regarding other parts of the response 116 as well. For instance, such other parts of the response 116 can be considered as comments that include the justification of the LLM 114 as to its reasoning in determining whether the test results 106 satisfy the verification statement 108. In this case, the response semantics 212 can provide the information that the LLM 114 is expected to provide when generating the response 116.

For each value that the LLM 114 can choose from to provide its assessment as to whether the AUT 102 is operating as expected, the response semantics 212 may include information that the LLM 114 is expected to provide when choosing that value. For instance, if the LLM 114's assessment is the AUT 102 is not performing its intended functionality, the semantics 212 can include the information that the LLM 114 is to provide to explain why it has concluded this. This information can be different from the information that the LLM 114 is to provide when its assessment is the AUT 102 is operating as expected.

The system prompt 204 can include general information 214 regarding how the LLM 114 is to generate the response 116 that is not specific to the AUT 102, the intended functionality of the AUT 102, or the verification statement 108. The general information 214 can be considered as instructions as to what the LLM 114 is to do in order to fulfill the statement of purpose 208. These instructions may provide particular information as to the overall principles that the LLM 114 is to keep in mind when generating the response 116. One such type of information includes policy decisions that the LLM 114 is to take into account when determining whether the test results 106 satisfy the statement 108.

Furthermore, the instructions can include particular knowledge that is not part of the LLM 114's base knowledge or a reiteration of things the LLM 114 does know in principle, with the purpose of making the LLM 114 specifically focus on this information. The instructions can also include particular facts about the testing process by which the AUT 102 has been tested in generating the test results 106, which are relevant to performing its task. For example, the testing of the AUT 102 that was performed to generate the test results 106 may have played back a test script that was recorded as a testing engineer manually tested the AUT 102. Being aware of this information may permit the LLM 114 to better analyze the test results 106 vis-à-vis the verification statement 108.

The user prompt 202 can include the test results 106 and the verification statement 108, as well as one or more prompting examples 206. The test results 106 and/or the verification statement 108 may be represented in the user prompt 202 in a format different than that in which they were respectively received from the testing of the AUT 102 and from the user. As a particular example, the test results 106 may originally be generated as captured screenshots of the GUI exposed by the AUT 102 while it is undergoing testing. The test results 106 as included in the user prompt 202, by comparison, may be text included in the screenshots that is generated by performing OCR.

The prompting examples 206 can be user-provided, and can assist the LLM 114 in determining whether the test results 106 satisfy the verification statement 108. The prompting examples 206 may be generated by the same user that generated the verification statement 108, such as a testing engineer responsible for testing the AUT 102. When no prompting examples 206 are provided, the resulting response 116 generated by the LLM 114 based on the prompt 112 is considered zero-shot prompting. That is, the LLM 114 is asked to do something (e.g., determine whether the test results 106 satisfy the verification statement 108) that it may have not been trained to do.

By comparison, when one or more prompting examples 206 are provided, the resulting response 116 generated by the LLM 114 based on the prompt 112 is considered one-shot or few-shot prompting, depending on whether just one example 206 is provided or more than one example 206 is provided.

Such prompting means that the LLM 114 is asked to solve a new task (e.g., determine whether the test results 106 satisfy the verification statement 108) that it may not have been trained to do, while providing examples 206 as to how the task should be solved.

One- or few-shot prompting is akin to passing a small sample of training data to the LLM 114 as part of the prompt 112, allowing the LLM 114 to learn from the user-provided prompting examples 206. However, unlike during actual training of the LLM 114, such as in the pretraining or finetuning stages described above, the learning process does not involve updating the LLM 114 (e.g., updating weights of the LLM 114 that may have been specified during actual training). Instead, the LLM 114 stays frozen but uses the provided examples 206 as context when generating the response 116.

The prompting examples 206 can thus each include example test results and whether the example test results satisfy the verification statement 108 or not. For example, a testing engineer or other user may, in addition to providing the verification statement 108, provide example sets of test results, and for each set indicate whether the verification statement 108 is satisfied or not. Providing just a handful of prompting examples 206 in this regard (e.g., less than five) can improve the accuracy of the LLM 114 in generating the response 116 when provided with the prompt 112 as input.

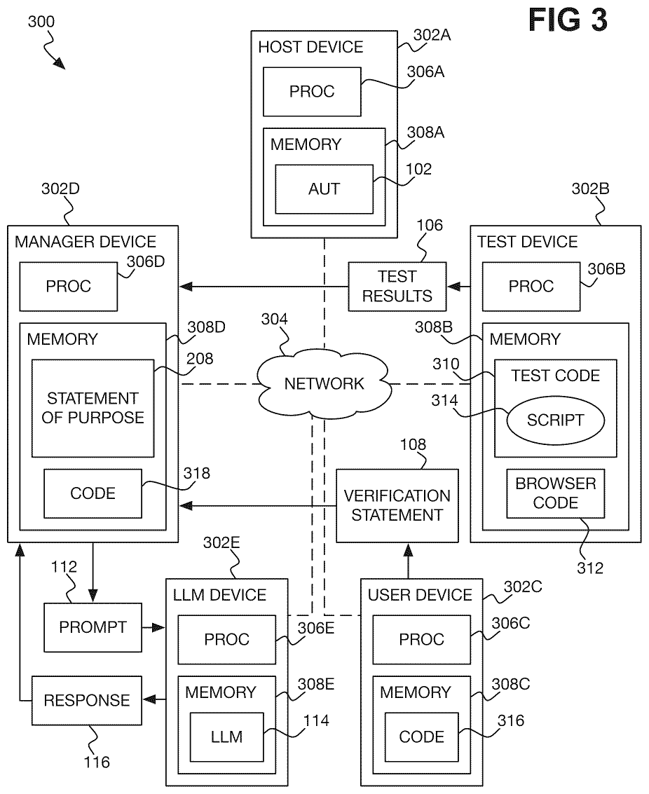

FIG. 3 shows an example system 300 for using a LLM 114 to determine whether an AUT 102 is performing its intended functionality. The system 300 can include a host device 302A, a test device 302B, a user device 302C, a manager device 302D, and an LLM device 302E, which are communicatively connected to one another via a network 304. The network 304 may be or include the Internet, intranets, extranets, local-area networks, wide-area networks, wireless networks, wired networks, telephony networks, etc.

The devices 302A, 302B, 302C, 302D, and 302E are collectively referred to as the devices 302, and each may be implemented as one or more computing devices. The devices 302A, 302B, 302C, 302D, and 302E respectively include processors 306A, 306B, 306C, 306D, and 306E and memories 308A, 308B, 308C, 308D, and 308E. The processors 306A, 306B, 306C, 306D, and 306E are collectively referred to as the processors 306. The memories 308A, 308B, 308C, 308D, and 308E are collectively referred to as the memories 308.

The host device 302A, the manager device 302D, and the LLM device 302E may each be a server or another type of computing device. The user device 302C may be a desktop, laptop, or another type of computer, a mobile computing device like a smartphone or a tablet computing device, and so on. The test device 302B may be a server, client, or another type of computing device. The functionality ascribed to two or more of the devices 302B, 302D, and 302E herein may instead be subsumed by just one computing device. For example, rather than there being separate manager and LLM devices 302D and 302E, there may be just one computing device performing both their functionality. Similarly, the functionality ascribed to the devices 302B and 302C may be subsumed by just one computing device.

In the example, the processor 306A of the host device 302A at least partially runs or executes the AUT 102 from the memory 308A. In the example, the processor 306B of the test device 302B runs or executes browser code 312 and test code 310 from the memory 308B. The test code 310 can include a test script 314 by which the AUT 102 is tested. In the specific example that is depicted, execution of the test code 310 can result in interaction of a GUI of the AUT 102 via the browser code 312. (More generally, however, the browser code 312 does not have to be included.)

The AUT 102 may transmit a web page formatted in accordance with a markup language to the browser code 312, which responsively renders and displays the web page. A hyperlink or other GUI objects is selected at the browser code 312 as controlled by the test code 310 in accordance with the test script 314, or input is otherwise provided in the context of the GUI.

This information is transmitted back to the AUT 102, which may then transmit another web page, and so on. The processor 306B of the client test device 302B may also partially run the AUT 102. The GUI of the AUT 102 may not be actually displayed or even rendered in some cases as well, depending on the test code 310 in question, and in some implementations the browser code 312 may not be included or otherwise controlled by the test code 310.

Information transmitted by the AUT 102, at least at conclusion of execution of the ordered steps of the test script 314, can constitute the test results 106 of the AUT 102 in accordance with the script 314. The test results 106 are transmitted to the manager device 302D.

The processor 306C of the user device 302C executes program code 316 from the memory 308C to permit a user to generate the verification statement 108 and transmit the statement 108 to the manager device 302D. The user device 302C may, for instance, be the computing device of the testing engineer or other user who is responsible for testing the AUT 102. The processor 306D of the manager device 302D executes program code 318 from the memory 308D. The memory 308D also can store the statement of purpose 208 that has been described above, and may further store any other constituent parts of the system prompt 204 of FIG. 2.

Via execution of the program code 318 from the memory 308D, the processor 306D of the manager device 302D receives the test results 106 and the user-generated verification statement 108 and generates the LLM prompt 112. The prompt 112 can be generated to include the test results 106, the verification statement 108, and the statement of purpose 208, as well as any other constituent parts of the prompt 112 that have been described above. The processor 306D transmits the prompt 112 from the manager device 302D to the LLM device 302E.

The processor 306E of the LLM device 302E executes, runs, or otherwise implements the LLM 114 from the memory 308E. The LLM 114 may be a publicly available LLM, or may be an LLM that is specifically for the enterprise or other organization that is developing the AUT 102 being tested.

The LLM device 302E receives the prompt 112 from the manager device 302D, which is provided as input to the LLM 114 to generate a response 116 as output. The response 116 is transmitted to the manager device 302D, and via the processor 306D thereof executing the code 318 stored in the memory 308D, the response 116 is analyzed to determine whether the LLM 114 has indicated the test results 106 satisfy the verification statement 108 or not.

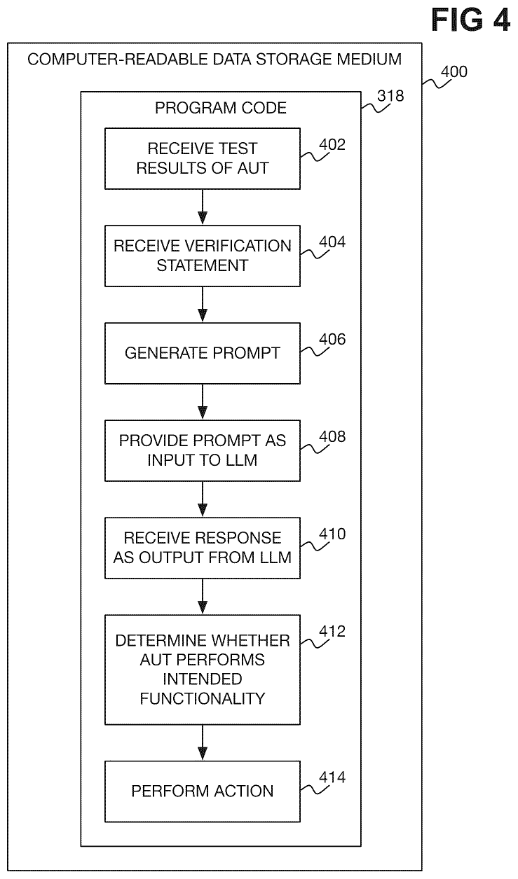

FIG. 4 shows an example non-transitory computer-readable data storage medium 400 storing the program code 318 that is executable by the processor 306D of the manager device 302D to perform processing. The data storage medium 400 may be the memory 308D of the manager device 302D, for instance. The processing includes receiving test results 106 of an AUT 102 that is tested to determine whether the AUT performs intended functionality (402), and receiving a user-generated verification statement 108 regarding the test results 106 of the AUT 102 (404).

The processing includes generating a prompt 112 to input to an LLM 114 based on the test results 106 and the verification statement 108 (406). As has been described, the prompt 112 is generated to solicit a response 116 from the LLM 114 including at least whether the test results 106 satisfy the verification statement 108. The processing includes providing the generated prompt 112 as input to the LLM 114 (408), and receiving the response 116 as output from the LLM 114 (410). The processing includes determining whether the AUT 102 performs its intended functionality based on the received response 116 (412), and can include performing an action based on whether the AUT 102 has been determined to be operating as expected (414).

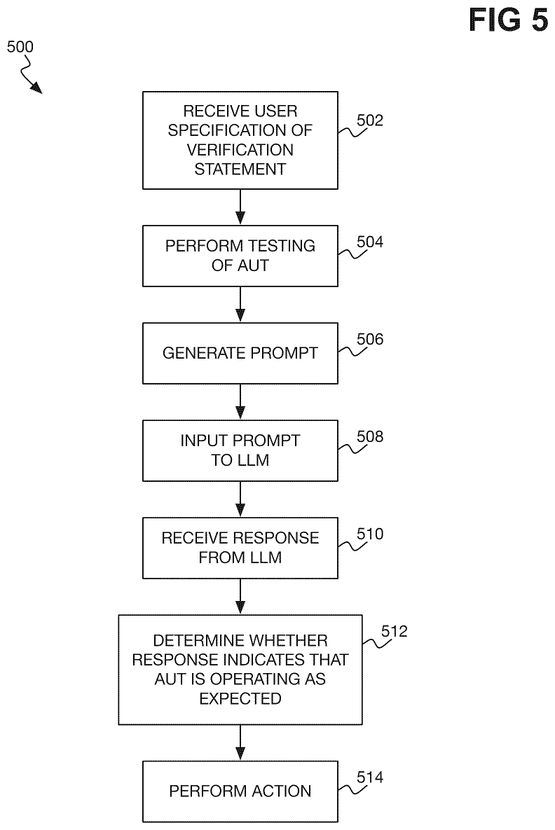

FIG. 5 shows a method 500 that can be performed by or in the context of the system 300 that has been described. The method 500 includes receiving user specification of a verification statement 108 as to whether test results 106 of an AUT 102 indicate that the AUT 102 is operating as expected (502), and performing testing of the AUT 102 to generate the test results 106 (504). The method 500 includes generating a prompt 112 to input to an LLM 114 based on the test results and the verification statement 108 (506). The prompt 112 is generated to solicit a response 116 from the LLM 114 including at least whether the test results 106 indicate that the AUT 102 is operating as expected in accordance with the verification statement 108.

The method 500 includes inputting the generated prompt 112 to the LLM 114 (508), and receiving the response 116 as output from the LLM 114 (510). The method 500 can include determining whether the response 116 received from the LLM 114 indicates that the LLM 114 has determined that the test results 106 denote that the AUT 102 is operating as expected in accordance with the verification statement 108 (512). The method 500 can include performing an action based on whether the response 116 received from the LLM 114 indicates that the AUT 102 is operating as expected (514).

Techniques have been described to leverage LLMs 114 during application testing. Specifically, an LLM 114 can be used to analyze test results 106 generated during testing of an AUT 102 in order to assess whether the test results 106 conform to a verification statement 108 and thus whether the AUT 102 is performed its intended functionality and operating as expected. By using an LLM 114 as described, the verification statement 108 does not have to be program code and does not have to be a regular expression, but rather can be a natural language statement.

Therefore, such verification statements 108 can be crafted even by users, such as testing engineers, who may not be skilled in programming or regular expressions, and the statements are more easily understood than program code and regular expressions. Furthermore, usage of such natural language verification statements 108 by LLMs 114 can result in more accurate analysis of the test results 106 than would occur via analysis of the test results 106 vis-à-vis verification statements in the form of program code or regular expressions without utilization of an LLM 114.

We claim:

1. A non-transitory computer-readable data storage medium storing program code executable by a computing device to perform processing comprising:
receiving test results of an application under test (AUT) that is tested to determine whether the AUT performs intended functionality;
receiving a user-generated verification statement regarding the test results of the AUT;
generating a prompt to input to a large language model (LLM), based on the test results and the verification statement, the prompt generated to solicit a response from the LLM including at least whether the test results of the AUT satisfy the verification statement;
providing the generated prompt as input to the LLM, and receiving the response as output from the LLM; and
determining whether the AUT performs the intended functionality based on the received response.

2. The non-transitory computer-readable data storage medium of claim 1, wherein the processing further comprises:
performing an action based on whether the AUT has been determined to have performed the intended functionality.

3. The non-transitory computer-readable data storage medium of claim 1, wherein the user-generated verification statement comprises a natural language statement as to how to determine whether the test results of the AUT indicate that the AUT performs the intended functionality.

4. The non-transitory computer-readable data storage medium of claim 1, wherein the prompt includes at least the test results and the verification statement.

5. The non-transitory computer-readable data storage medium of claim 4, wherein the prompt further includes one or more user-provided prompting examples to assist the LLM in determining whether the test results of the AUT satisfy the verification statement.

6. The non-transitory computer-readable data storage medium of claim 4, wherein the prompt further includes a statement of purpose of the LLM as to a role of the LLM and as to what the LLM is expected to do in generating the response.

7. The non-transitory computer-readable data storage medium of claim 6, wherein the statement of purpose of the LLM is not specific to the AUT, the intended functionality of the AUT, or the verification statement.

8. The non-transitory computer-readable data storage medium of claim 6, wherein generating the prompt to input to the LLM to solicit the response from the LLM comprises:
generating a system prompt that is not specific to the AUT, the intended functionality of the AUT, or the verification statement, the system prompt including the statement of purpose of the LLM; and
generating a user prompt that is specific to at least the verification statement, the user prompt including at least the test results and the verification statement.

9. The non-transitory computer-readable data storage medium of claim 6, wherein the prompt further includes one or more of:
an output format of the response that the LLM is to output;
semantics of the response that the LLM is to output; and
general information regarding how the LLM is to generate the response that is not specific to the AUT, the intended functionality of the AUT, or the verification statement.

10. A method comprising:
receiving user specification of a verification statement as to whether test results of an application under test (AUT) indicate that the AUT is operating as expected;
performing testing of the AUT to generate the test results;
generating a prompt to input to a large language model (LLM), based on the test results and the verification statement, the prompt generated to solicit a response from the LLM including at least whether the test results indicate that the AUT is operating as expected in accordance with the verification statement;
inputting the generated prompt to the LLM and receiving the response as output from the LLM; and
performing an action based on whether the response received from the LLM indicates that the AUT is operating as expected.

11. The method of claim 10, further comprising:
determining whether the response received from the LLM indicates that the LLM has determined that the test results indicate that the AUT is operating as expected in accordance with the verification statement.

12. The method of claim 10, wherein the prompt includes at least the test results and the verification statement.

13. The method of claim 12, wherein the prompt further includes one or more user-provided prompting examples to assist the LLM in determining whether the test results indicate that the AUT is operating as expected in accordance with the verification statement.

14. The method of claim 12, wherein the prompt further includes a statement of purpose of the LLM as to a role of the LLM and as to what the LLM is expected to do in generating the response.

15. The method of claim 14, wherein the statement of purpose of the LLM is not specific to the AUT or the verification statement.

16. A system comprising:
a memory storing program code; and
a processor configured to execute the program code to perform processing comprising:
receiving test results of an application under test (AUT) that is tested to determine whether the AUT performs intended functionality;
receiving a user-generated verification statement regarding the test results of the AUT;
generating a prompt to input to a large language model (LLM) to solicit a response from the LLM including at least whether the test results of the AUT satisfy the verification statement, the prompt including at least the test results and the verification statement;
providing the generated prompt as input to the LLM, and receiving the response as output from the LLM; and
determining whether the AUT performs the intended functionality based on the received response.

17. The system of claim 16, wherein the processing further comprises:
performing an action based on whether the AUT has been determined to have performed the intended functionality.

18. The system of claim 16, wherein the generated prompt further includes one or more user-provided prompting examples to assist the LLM in determining whether the test results of the AUT satisfy the verification statement.

19. The system of claim 16, wherein the memory stores a statement of purpose of the LLM as to a role of the LLM and as to what the LLM is expected to do in generating the response,
and wherein the generated prompt includes the statement of purpose of the LLM.

20. The system of claim 19, wherein the statement of purpose of the LLM is not specific to the AUT, the intended functionality of the AUT, or the verification statement.
